(19) United States
(12) Patent Application Publication
(10) Pub. No.: US 2026/0310651 A1
(43) Pub. Date: Oct. 8, 2026

(54) MANAGING AUDIT TABLES IN DATABASE ENVIRONMENTS

(71) Applicant: International Business Machines Corporation, Armonk, NY (US)

(72) Inventors: Shailesh Chandra Jamloki, Noida (IN); Pavan Gilda, Jodhpur (IN)

(21) Appl. No.: 19/097,923

(22) Filed: Apr. 2, 2025

(51) Int. Cl. G06F 16/23; G06F 16/22

(52) U.S. Cl. CPC G06F 16/2358; G06F 16/2282; G06F 16/2365

(57) ABSTRACT

Methods for managing audit tables in a database system are provided. Aspects include receiving, by the database system, a request from a user to designate a table of the database system as an audit table and validating, by the database system, that the table satisfies an audit table criteria. Based on a determination that the table satisfies the audit table criteria, aspects also include updating a metadata of the table to designate the table as the audit table, wherein an audit table designation changes logging settings of the table in the database system.

### BACKGROUND

The present disclosure pertains to database management systems, specifically to optimizing and managing audit tables within database management systems.

In database management systems, audit tables are often used in maintaining records of operations performed on databases. These tables typically store data such as the identity of the user or application making changes, timestamps, and the type of operation executed. Audit tables are treated like regular tables by database systems, leading to inefficiencies. This uniform treatment fails to account for the specific characteristics of audit tables, which are predominantly write-heavy and rarely require updates or deletions. As a result, database systems may apply default settings that lead to excessive logging and replication, consuming unnecessary resources and reducing performance.

Current database systems lack mechanisms to optimize the treatment of audit tables based on their specific usage patterns. This oversight results in increased storage requirements and processing overhead, particularly in cloud environments where costs are tied to data volume. Furthermore, replication processes are hindered by the need to process unnecessary update and delete logs, which can slow down operations and waste valuable resources.

### SUMMARY

Embodiments of the present disclosure are directed to computer-implemented methods for managing audit tables in a database system. According to an aspect, a computer-implemented method includes receiving, by the database system, a request from a user to designate a table of the database system as an audit table and validating, by the database system, that the table satisfies an audit table criteria. Based on a determination that the table satisfies the audit table criteria, aspects also include updating a metadata of the table to designate the table as the audit table. The audit table designation changes logging settings of the table in the database system.

Embodiments also include computer systems and computer program products for managing a connection pool for cloud-based applications accessing databases.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram of an example computer system for use in conjunction with one or more embodiments of the present disclosure;

FIG. 2 depicts a block diagram of a database system in accordance with one or more embodiments of the present disclosure;

FIG. 3 depicts a block diagram of an audit table of a database system in accordance with one or more embodiments of the present disclosure; and

FIG. 4 depicts a flowchart of a method for managing audit tables in a database system in accordance with one or more embodiments of the present disclosure.

### DETAILED DESCRIPTION

In database management systems, audit tables are used to record database operations, capturing details such as user identity, timestamps, and operation types. However, these tables are often managed like standard tables, which leads to inefficiencies. This approach overlooks the unique characteristics of audit tables, which are primarily focused on write operations and seldom require updates or deletions. Consequently, default system settings can result in excessive logging and replication, wasting resources and degrading performance. Current database systems do not have the capability to optimize audit tables based on their distinct usage patterns. This limitation leads to increased storage demands and processing overhead, especially in cloud environments where costs are linked to data volume. Additionally, replication processes are burdened by unnecessary update and delete logs, slowing down operations and wasting resources.

The present disclosure addresses these challenges by introducing a novel approach to managing audit tables within database systems. The disclosed methods and systems allow users to designate tables as audit tables, enabling the database system to apply specialized settings and optimizations tailored to the specific characteristics of these tables. By updating the metadata to reflect the audit table designation, the system can limit logging to insert operations, implement time-based partitioning, and apply efficient data compression techniques. This approach not only enhances performance but also reduces storage costs, particularly in cloud environments. Additionally, the disclosure facilitates improved replication processes by allowing the system to ignore unnecessary update and delete logs, thereby optimizing resource utilization and reducing operational overhead.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as optimization and management of audit tables within database management systems (block 150). In addition to block 150, computing environment 100 includes, for example, computer 101, wide area network (WAN) 102, end user device (EUD) 103, remote server 104, public Cloud 105, and private Cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IOT) sensor set 135), and network module 115. Remote server 104 includes remote database 132. Public Cloud 105 includes gateway 130, Cloud orchestration module 131, host physical machine set 142, virtual machine set 143, and container set 144.

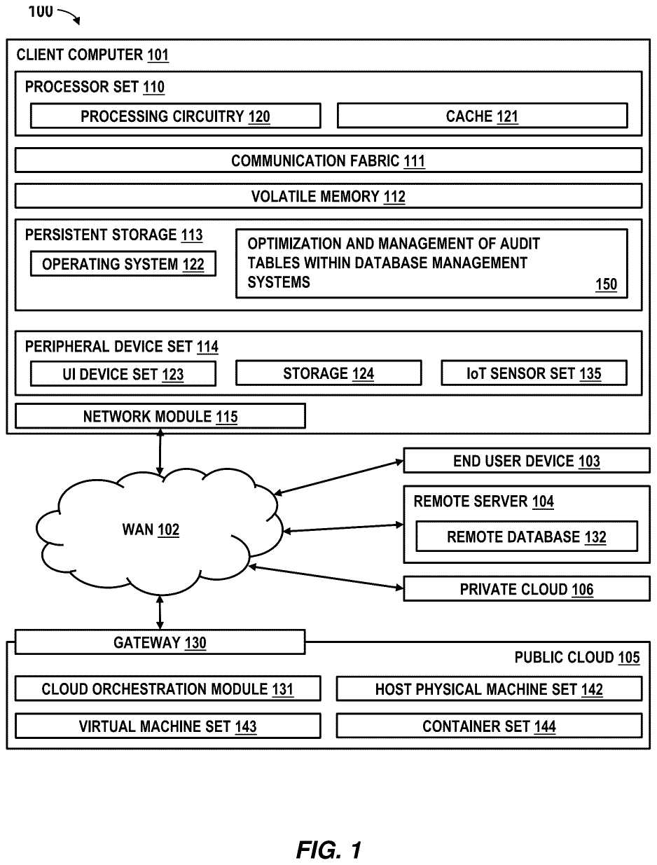

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 132. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a Cloud, even though it is not shown in a Cloud in FIG. 1. On the other hand, computer 101 is not required to be in a Cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 135 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 132 of remote server 104.

PUBLIC CLOUD 105 is any computer system available for use by multiple entities that provides on-demand availability of computer system resources and/or other computer capabilities, especially data storage (Cloud storage) and computing power, without direct active management by the user. Cloud computing typically leverages sharing of resources to achieve coherence and economies of scale. The direct and active management of the computing resources of public Cloud 105 is performed by the computer hardware and/or software of Cloud orchestration module 131. The computing resources provided by public Cloud 105 are typically implemented by virtual computing environments that run on various computers making up the computers of host physical machine set 142, which is the universe of physical computers in and/or available to public Cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 131 manages the transfer and storage of images, deploys new instantiations of VCEs and manages active instantiations of VCE deployments. Gateway 130 is the collection of computer software, hardware, and firmware that allows public Cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public Cloud 105, except that the computing resources are only available for use by a single enterprise. While private Cloud 106 is depicted as being in communication with WAN 102, in other embodiments a private Cloud may be disconnected from the internet entirely and only accessible through a local/private network. A hybrid Cloud is a composition of multiple Clouds of different types (for example, private, community or public Cloud types), often respectively implemented by different vendors. Each of the multiple Clouds remains a separate and discrete entity, but the larger hybrid Cloud architecture is bound together by standardized or proprietary technology that enables orchestration, management, and/or data/application portability between the multiple constituent Clouds. In this embodiment, public Cloud 105 and private Cloud 106 are both part of a larger hybrid Cloud.

One or more embodiments described herein can utilize machine learning techniques to perform prediction and or classification tasks, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input.

A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

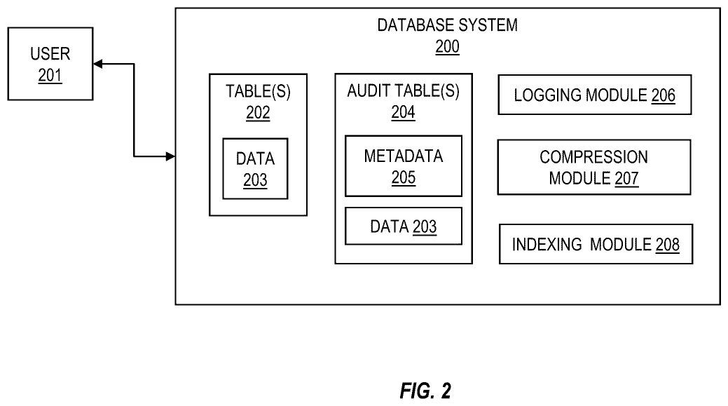

Referring now to FIG. 2, a block diagram of a system 200 for database system 200 in accordance with one or more embodiments of the present disclosure is shown. In one embodiment, a user 201 interacts with the database system 200 and serves as the initiator of interactions with the database system 200. The user 201 is responsible for designating tables within the database system 200 as audit tables, thereby influencing how these tables are managed and optimized by the database system 200.

In exemplary embodiments, the database system 200 orchestrates the management and optimization of tables, including tables 202 and audit tables 204, within the database system 200. The database system 200 is responsible for receiving requests from the user 201 and executing operations based on these requests. The database system 200 encompasses various modules and functionalities that work in tandem to enhance the performance and efficiency of audit tables 204. The database system 200 validates the criteria for audit tables, updates metadata, and applies specialized settings such as time-based partitioning and data compression. The database system 200 interacts with other components, such as the logging module 206, compression module 207, and indexing module 208, to ensure that audit tables are managed according to their specific usage patterns. This system-wide coordination allows for the optimization of resources and the reduction of unnecessary overhead, particularly in cloud environments where data volume directly impacts costs.

In exemplary embodiments, the tables 202 within the database system 200 represent the general data structures that store information. These tables 202 can be designated as audit tables by the user 201, which triggers a series of optimizations and management processes within the database system 200. The tables 202 store data 203, which can include a wide range of types of information. When a table is designated as an audit table 204, the database system 200 updates a metadata 205 of the table to reflect this designation, allowing for specialized treatment of the audit table 204. In exemplary embodiments, both the tables 202 and the audit tables 204 are subject to operations such as logging, compression, and indexing, however, the database system 200 is configured to perform these operations in different manners for tables 202 and the audit tables 204.

In exemplary embodiments, audit tables 204 are specialized tables within the database system 200 that are designated by the user 201 for optimized management by the database system 200. The audit tables 204 are characterized by their write-heavy nature, primarily involving insert operations, and their minimal need for updates or deletions. The audit tables 204 store data 203, which includes information such as timestamps and operation types. In exemplary embodiments, the database system 200 applies specific settings to audit tables 204, such as limiting logging to insert operations and implementing time-based partitioning. The metadata 205 associated with audit tables 204 is updated to reflect their designation, enabling the system to apply specialized compression techniques and enforce data retention policies. In exemplary embodiments, the audit tables 204 benefit from reduced logging and efficient data management, which improves performance and reduces costs in cloud environments.

In exemplary embodiments, the metadata 205 is associated with audit tables 204 and provides the database system 200 with information about the table's designation and usage patterns. When a table is designated as an audit table 204, the metadata 205 is updated to reflect this status, allowing the system to apply specialized settings and optimizations. The metadata 205 enables the database system 200 to tailor management processes to the specific characteristics of audit table(s) 204, ensuring efficient data handling and resource utilization. The metadata 205 plays a role in enabling the database system 200 to enforce data retention policies and apply compression techniques specific to the audit table 204, which are configured to optimize performance and reducing storage requirements of the database system 200.

In exemplary embodiments, the logging module 206 within the database system 200 is responsible for managing the logging operations associated with tables 202 and audit tables 204. The logging module 206 is configured to log all transactions for tables 202 and to limit the logging of transactions of the audit table 204 to insert operations, thereby reducing the overhead associated with unnecessary update and delete logs of the audit table 204. The logging module 206 interacts with the metadata 205 to determine the appropriate logging settings for each table, ensuring that only necessary information is recorded. This approach minimizes the impact on storage and processing resources, particularly in cloud environments where data volume directly affects costs.

In exemplary embodiments, the compression module 207 is tasked with implementing data compression techniques for the tables 202 and audit tables 204 within the database system 200. The compression module 207 leverages the metadata 205 to apply different compression methods to the audit tables 204 and other tables. The data compression techniques applied to the audit table are specifically configured to reduce the storage requirements of audit tables 204 by compressing repeated information, such as timestamps and operation types, to optimize space utilization. By reducing the data footprint of audit tables 204, the compression module 207 enhances the performance of the database system 200 and lowers costs associated with data storage.

In exemplary embodiments, the indexing module 208 is responsible for generating and managing indexes on the tables 202 and audit tables 204 within the database system 200. The indexing module 208 interacts with the metadata 205 to determine the appropriate indexing strategy for the tables 202 and audit tables 204, ensuring that queries are executed efficiently. For example, the indexing module 208 may be configured to automatically create indexes for the audit table 204 on common query columns, such as the timestamp column, to optimize query performance. By prioritizing efficient data insertion over complex indexing, the database system 200 improves the responsiveness of queries on the audit table 204.

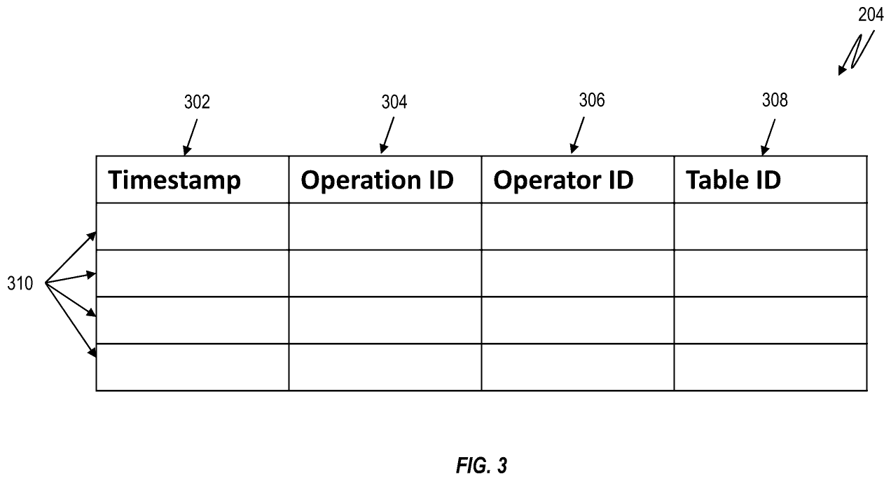

FIG. 3 shows an embodiment of an audit table 204 within a database system 200, illustrating the structure and components of the audit table 204. In exemplary embodiments, the audit table 204 includes several columns, including Timestamp 302, Operation ID 304, Operator ID 306, and Table ID 308. Each row in the audit table 204 represents an audit record entry (ARE) 310, capturing important information about database operations. In exemplary embodiments, the audit Timestamp 302 records the specific time at which each operation is performed. This enables accurate tracking and chronological ordering of database activities, aiding in thorough auditing and analysis. In exemplary embodiments, the audit Operation ID 304 column in the audit table 204 identifies the specific operation executed on the database. The Operation ID is used to distinguish between different types of operations, such as insertions, updates, or deletions, thereby providing a clear understanding of the actions taken within the database system. In exemplary embodiments, the Operator ID 306 indicates the identity of the user or system entity that performed the operation of the ARE 310. This information is necessary for accountability and security, enabling the tracing of actions back to the responsible party. In exemplary embodiments, the Table ID 308 in the audit table 204 specifies the particular table within the database that was affected by the operation of the ARE 310. Each audit record entry (ARE) 310 in the audit table 204 encapsulates the data from the aforementioned columns, providing a complete snapshot of each database operation. The ARE 310 ensures that all relevant information is captured and stored efficiently, supporting robust audit processes and compliance with data governance standards.

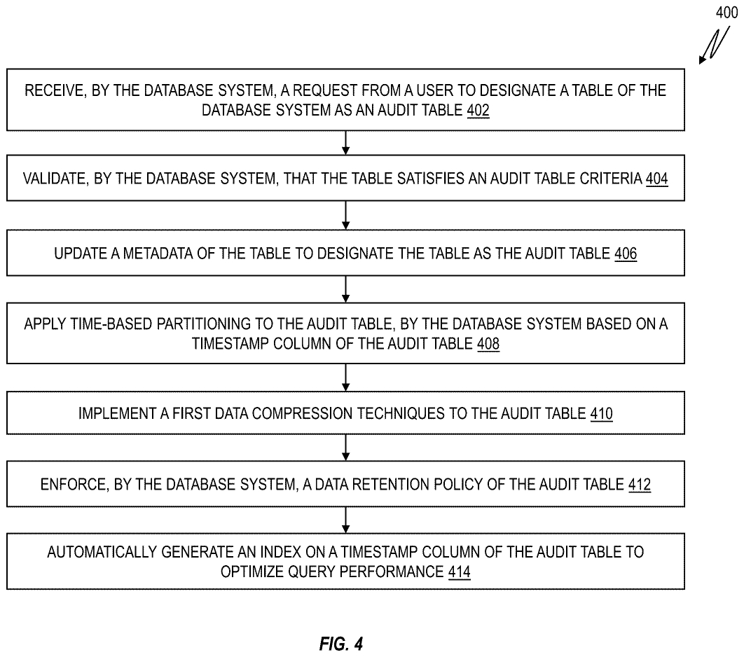

Referring now to FIG. 4, a flowchart of a method for managing audit tables in a database system in accordance with one or more embodiments of the present disclosure is shown. In one embodiment, the method 400 is performed by a database system 200 such as the one shown in FIG. 2.

At block 402, the method 400 involves receiving, by the database system, a request from a user to designate a table of the database system as an audit table. This step can be performed by allowing the user to interact with the database system through a user interface or API, where the user specifies the table to be designated as an audit table. For example, the user might select a table from a list of existing tables and mark it for audit purposes.

Next, as shown at block 404, the method 400 includes validating, by the database system, that the table satisfies an audit table criteria. In exemplary embodiments, this validation process involves checking the table's structure and metadata to ensure it meets predefined criteria, such as the presence of a timestamp column. The database system may perform this validation by querying the table's schema and verifying that all necessary columns and attributes are present.

In exemplary embodiments, the validation process for designating a table as an audit table involves checking the table's structure and metadata against a set of predefined criteria. Beyond the presence of a timestamp column, other criteria may include the existence of specific columns such as an operation type column, which records the nature of database operations, and an operator ID column, which identifies the user or system entity responsible for the operation. Additionally, the audit table may require a table ID column to specify the affected table within the database system.

In exemplary embodiments, the audit table criteria can be set by a user or database administrator through a configuration interface or API provided by the database system. This interface allows the user or administrator to define the criteria based on the specific needs and usage patterns of the audit tables. For instance, they may specify the required columns, data types, and any additional attributes that the audit table must possess. The criteria can be adjusted to accommodate different business logic and operational requirements, ensuring that the audit table is optimized for its intended purpose. Once defined, the audit table criteria are stored within the database system's configuration files or metadata repository. This storage ensures that the criteria are accessible for validation processes whenever a table is designated as an audit table. The criteria may be stored in a structured format, such as XML or JSON, allowing for easy retrieval and modification by authorized users or administrators. By maintaining the criteria in a centralized location, the database system can efficiently validate tables against the established standards, ensuring consistency and compliance across all audit tables within the system.

At block 406, the method 400 involves updating a metadata of the table to designate the table as the audit table. This step includes modifying the table's metadata to reflect its new status as an audit table, which may involve setting specific flags or attributes in the database system. For instance, the metadata update might include adding an “audit” flag to the table's properties, indicating that it should be treated with specialized settings.

Next, as shown at block 408, the method 400 includes applying time-based partitioning to the audit table, by the database system based on a timestamp column of the audit table. This step involves configuring the audit table to partition its data based on time intervals, which can improve query performance and data management. The database system may automatically create partitions for the audit table, using the timestamp column to determine the boundaries of each partition.

At block 410, the method 400 involves implementing a first data compression technique to the audit table. This step includes applying specialized compression algorithms to the audit table to reduce its storage footprint. The database system may select a compression technique optimized for the type of data stored in the audit table, such as compressing repeated information like timestamps and operation types.

In exemplary embodiments, the compression technique applied to the audit table is specifically tailored to address the unique characteristics and data patterns of audit tables, which differ from those of regular tables in the database system. Audit tables are predominantly write-heavy and primarily involve insert operations, often containing repeated information such as timestamps, operation types, and user identifiers. As a result, the compression technique for audit tables focuses on optimizing the storage of these repetitive data elements. In contrast, compression techniques applied to other tables in the database system may not prioritize the same data patterns. Regular tables might involve a more diverse range of operations, including frequent updates and deletions, and may store a wider variety of data types and structures. Consequently, the compression algorithms for these tables are generally designed to handle a broader spectrum of data variability and may not be as finely tuned to the specific patterns found in audit tables.

In exemplary embodiments, the specialized compression technique for audit tables leverages the predictability and repetition of audit data to achieve higher compression ratios, thereby reducing the storage footprint more effectively than general-purpose compression methods. This approach not only enhances storage efficiency but also improves data retrieval performance by minimizing the amount of data that needs to be processed during query execution. By focusing on the unique characteristics of audit tables, the database system can apply a compression strategy that maximizes space utilization and optimizes performance, particularly in environments where storage costs are a significant concern.

Next, as shown at block 412, the method 400 includes enforcing, by the database system, a data retention policy of the audit table. This step involves setting rules for how long data should be retained in the audit table before being archived or deleted. The database system may automatically enforce these retention policies based on configurable parameters, ensuring that the audit table does not consume excessive storage resources over time.

At block 414, the method 400 involves automatically generating an index on a timestamp column of the audit table to optimize query performance. This step includes creating indexes on the audit table to enhance the speed and efficiency of queries. The database system may analyze query patterns to determine the most effective indexing strategy, ensuring that the audit table can be queried quickly and efficiently.

In one embodiment, the audit table is configured to restrict logging of update and delete operations by implementing a minimal logging strategy that records only necessary metadata, such as the operation type and timestamp, without capturing the full data image. This approach reduces storage requirements and enhances system performance. In another embodiment, the database system employs a rule-based engine to determine the minimal information required for maintaining audit trails, allowing for dynamic adjustment of logging parameters based on the specific needs of the application or user preferences. This engine could be configured to log additional metadata, such as user ID or session information, when certain conditions are met, providing flexibility in audit trail management. In yet another embodiment, the system could utilize a machine learning algorithm to analyze historical data access patterns and optimize the logging process by predicting which operations are likely to require detailed audit trails, thereby selectively enhancing logging granularity for those operations while maintaining minimal logging for others. Additionally, the system could offer an interface for administrators to manually adjust logging settings for specific audit tables, enabling fine-tuned control over the balance between audit trail comprehensiveness and system resource utilization.

In exemplary embodiments, the implementation of audit tables with specialized logging and management techniques can impact database recovery processes. By designating tables as audit tables and restricting logging to essential operations, such as inserts, the database system reduces the volume of log data that must be processed during recovery. This streamlined logging approach ensures that only critical data necessary for maintaining the integrity of audit trails is captured, thereby expediting the recovery process. During recovery, the system focuses on restoring insert operations, which are the primary concern for audit tables, ensuring that the essential historical records are preserved without the overhead of unnecessary update and delete logs. This targeted recovery strategy not only enhances the speed and efficiency of the recovery process but also minimizes resource consumption, particularly in cloud environments where data processing costs are a concern. By optimizing the recovery process through the use of audit tables, the database system maintains robust data integrity while reducing downtime and operational costs.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method for managing audit tables in a database system, the method comprising:
receiving, by the database system, a request from a user to designate a table of the database system as an audit table;
validating, by the database system, that the table satisfies an audit table criteria, wherein validating that the table satisfies the audit table criteria further comprises verifying a presence of a timestamp column for recording the time of each audit record insertion;
based on a determination that the table satisfies the audit table criteria, updating a metadata of the table to designate the table as the audit table, wherein an audit table designation changes logging settings of the table in the database system, and wherein the database system is configured to only log insert operations for the audit table;
applying time-based partitioning to the audit table, by the database system, based on a timestamp column of the audit table, the time-based partitioning comprising:
configuring the audit table to partition its data based on time intervals, which can improve query performance and data management; and
using the timestamp column to determine boundaries of each partition; and
automatically generating an index on a timestamp column of the audit table to optimize query performance.

2. The computer-implemented method of claim 1, further comprising configuring the audit table to restrict logging of update and delete operations to only record minimal information necessary for maintaining audit trails.

3. (canceled)

4. The computer-implemented method of claim 1, further comprising implementing a first data compression techniques to the audit table, wherein the first data compression technique is only applied to tables in the database system that are designated as audit tables.

5. The computer-implemented method of claim 1, further comprising enforcing, by the database system, a data retention policy of the audit table.

6. The computer-implemented method of claim 1, wherein the automatically generating of the index comprises analyzing query patterns to determine an indexing strategy.

7. (canceled)

8. (canceled)

9. A computer program product having one or more computer readable storage media having computer readable program code collectively stored on the one or more computer readable storage media, the computer readable program code being executed by a processor of a computer system to cause the computer system to perform operations comprising:
receiving, by a database system, a request from a user to designate a table of the database system as an audit table;
validating, by the database system, that the table satisfies an audit table criteria, wherein validating that the table satisfies the audit table criteria further comprises verifying a presence of a timestamp column for recording the time of each audit record insertion;
based on a determination that the table satisfies the audit table criteria, updating a metadata of the table to designate the table as the audit table, wherein an audit table designation changes logging settings of the table in the database system, and wherein the database system is configured to only log insert operations for the audit table;
applying time-based partitioning to the audit table, by the database system, based on a timestamp column of the audit table, the time-based partitioning comprising:
configuring the audit table to partition its data based on time intervals, which can improve query performance and data management; and
using the timestamp column to determine boundaries of each partition; and
automatically generating an index on a timestamp column of the audit table to optimize query performance; and
automatically generating an index on a timestamp column of the audit table to optimize query performance.

10. The computer program product of claim 9, wherein the operations further comprise configuring the audit table to restrict logging of update and delete operations to only record minimal information necessary for maintaining audit trails.

11. (canceled)

12. The computer program product of claim 9, wherein the operations further comprise implementing a first data compression techniques to the audit table, wherein the first data compression technique is only applied to tables in the database system that are designated as audit tables.

13. The computer program product of claim 9, wherein the operations further comprise enforcing, by the database system, a data retention policy of the audit table.

14. The computer program product of claim 9, wherein the automatically generating of the index comprises analyzing query patterns to determine an indexing strategy.

15. (canceled)

16. (canceled)

17. A computing system comprising:
a processor;
a memory coupled to the processor; and
one or more computer readable storage media coupled to the processor, the one or more computer readable storage media collectively containing instructions that are executed by the processor via the memory to cause the processor to perform operations comprising:
receiving, by a database system, a request from a user to designate a table of the database system as an audit table;
validating, by the database system, that the table satisfies an audit table criteria, wherein validating that the table satisfies the audit table criteria further comprises verifying a presence of a timestamp column for recording the time of each audit record insertion;
based on a determination that the table satisfies the audit table criteria, updating a metadata of the table to designate the table as the audit table, wherein an audit table designation changes logging settings of the table in the database system, and wherein the database system is configured to only log insert operations for the audit table;
applying time-based partitioning to the audit table, by the database system, based on a timestamp column of the audit table, the time-based partitioning comprising:
configuring the audit table to partition its data based on time intervals, which can improve query performance and data management; and
using the timestamp column to determine boundaries of each partition; and
automatically generating an index on a timestamp column of the audit table to optimize query performance; and
automatically generating an index on a timestamp column of the audit table to optimize query performance.

18. The computing system of claim 17, wherein the operations further comprise configuring the audit table to restrict logging of update and delete operations to only record minimal information necessary for maintaining audit trails.

19. (canceled)

20. The computing system of claim 17, wherein the operations further comprise implementing a first data compression techniques to the audit table, wherein the first data compression technique is only applied to tables in the database system that are designated as audit tables.
